(19) United States
(12) Patent Application Publication
(10) Pub. No.: US 2026/0075693 A1
(43) Pub. Date: Mar. 12, 2026

(54) NATURAL LANGUAGE INPUT FOR CONTROLLING A LIGHTING SYSTEM

(71) Applicant: Electronic Theatre Controls, Inc., Middleton, WI (US)

(72) Inventor: Christopher Mizerak, Oceanside, CA (US)

(21) Appl. No.: 19/317,470

(22) Filed: Sep. 3, 2025

Related U.S. Application Data
(60) Provisional application No. 63/692,467, filed on Sep. 9, 2024.

(51) Int. Cl. H05B 47/175; H05B 47/155

(52) U.S. Cl. CPC H05B 47/196; H05B 47/155

(57) ABSTRACT

A lighting system includes a lighting fixture, a user input, a machine learning controller configured to implement a natural language processing model and a lighting control trained model, and a lighting fixture controller. The lighting fixture controller is connected to the lighting fixture. The lighting fixture controller is configured to receive, through the user input, a natural language user input related to a desired lighting control for the lighting system, provide the natural language user input to the machine learning controller to be processed by the natural language processing model and the lighting control trained model, receive, from the machine learning controller, an output lighting control for controlling the lighting fixture, generate a drive signal for the lighting fixture based on the output lighting control, and transmit the drive signal to the lighting fixture to control an output of the lighting fixture to achieve the desired lighting control.

### RELATED APPLICATIONS

This application claims the benefit of U.S. Provisional Patent Application No. 63/692,467, filed Sep. 9, 2024, the entire content of which is hereby incorporated by reference.

### FIELD

Embodiments described herein relate to controlling one or more light fixtures in a lighting system.

### SUMMARY

When a lighting designer has a vision in his or her mind about how lighting should look and feel, he or she must currently control a lighting control console him or herself, or express that vision verbally to a human lighting control console operator. The console operator then has to use experience and expertise to convert that dialog into instructions for the available lighting fixtures.

Lighting systems described herein use a natural language user input (e.g., voice or text) and existing knowledge of a venue (e.g., lighting fixture locations, features, capabilities, proximity to other devices, venue size, etc.) to interpret the lighting designer's artistic vision using one or more trained machine learning models. Using the trained models, the lighting system can take the lighting designer's artistic vision as expressed in natural language, and convert that vision into corresponding lighting controls in effectively real-time. Such a system would allow the lighting designer to quickly change looks and movements, and quickly iterate with different artistic ideas.

For example, the lighting design would be able to use common industry nomenclature to express how a scene should be lighted. One prompt could be, as an example, “high noon, in a hot, sandy desert.” Such a directive could be followed with, for example, “I want long shadows and the green cactuses to really pop.” The machine learning models would be able to take these directives and generate the necessary lighting controls for the venue to control the lighting fixtures within their physical limitations

Lighting systems described herein include a lighting fixture, a user input, a machine learning controller configured to implement a natural language processing model and a lighting control trained model, and a lighting fixture controller. The lighting fixture controller is connected to the lighting fixture. The lighting fixture controller includes an electronic processor and a memory coupled to the electronic processor. The memory stores instructions that when executed by the electronic processor configure the electronic processor to receive, through the user input, a natural language user input related to a desired lighting control for the lighting system, provide the natural language user input to the machine learning controller to be processed by the natural language processing model and the lighting control trained model, receive, from the machine learning controller, an output lighting control for controlling the lighting fixture, generate a drive signal for the lighting fixture based on the output lighting control, and transmit the drive signal to the lighting fixture to control an output of the lighting fixture to achieve the desired lighting control.

Methods described herein for controlling a lighting system including a lighting fixture include receiving, through a user input, a natural language user input related to a desired lighting control for the lighting system, providing, to a machine learning controller, the natural language user input for processing by a natural language processing model and a lighting control trained model, receiving, from the machine learning controller, an output lighting control for controlling the lighting fixture, generating, using a lighting fixture controller, a drive signal for the lighting fixture based on the output lighting control, and transmit the drive signal to the lighting fixture to control an output of the lighting fixture to achieve the desired lighting control.

Lighting systems described herein include a plurality of lighting fixtures, a user input, a machine learning controller configured to implement a natural language processing model and a lighting control trained model, and lighting fixture controller. The lighting fixture controller is connected to the plurality of lighting fixtures. The lighting fixture controller includes an electronic processor and a memory coupled to the electronic processor. The memory stores instructions that when executed by the electronic processor configure the electronic processor to receive, through the user input, a natural language user input related to an artistic lighting expression for the lighting system, provide the natural language user input to the machine learning controller to be processed by the natural language processing model and the lighting control trained model, receive, from the machine learning controller, output lighting controls for controlling the plurality of lighting fixtures, generate drive signals for the plurality of lighting fixtures based on the output lighting controls, transmit the drive signals to the plurality of lighting fixtures, and control outputs of the plurality of lighting fixtures using the drive signals to achieve the artistic lighting expression.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather, these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a lighting system for identifying and controlling one or more light fixtures.

FIG. 2 illustrates a controller for the lighting system of FIG. 1.

FIG. 3 illustrates an example venue including a plurality of light fixtures represented as a map of light fixtures.

FIG. 4 illustrates a training system for a convolutional neural network with respect to a lighting system.

FIG. 5 is a process for training a convolutional neural network with respect to a lighting system.

FIG. 6 illustrates a training system for a generative adversarial network with respect to a lighting system.

FIG. 7 is a process for training a generative adversarial network with respect to a lighting system.

FIG. 8 illustrates a natural language user input for controlling a lighting system.

FIG. 9 illustrates a system for generating lighting controls for a lighting system using a natural language user input.

FIG. 10 illustrates a system for generating lighting controls for a lighting system using a natural language user input.

FIG. 11 is a process for controlling a lighting system using a natural language user input.

### DETAILED DESCRIPTION

Lighting systems described herein use a natural language user input (e.g., voice or text) and existing knowledge of a venue (e.g., lighting fixture locations, features, capabilities, proximity to other devices, venue size, etc.) to interpret a lighting designer's artistic vision using a lighting control trained model and an artistic vision trained model. A lighting system including one or more light fixtures and a user input can receive the natural language user input related to the lighting designer's artistic vision. The natural language user input can be provided to a machine learning controller that can process the natural language user input to interpret and understand the intention of the lighting designer. The lighting control trained model and the artistic vision trained model can then be used to generate the lighting controls necessary to achieve the lighting designer's artistic vision. The lighting controls can be provided to a lighting fixture controller to generate corresponding drive signals for the one or more light fixtures. The drive signals are provided to the one or more light fixtures to control the outputs of the one or more light fixtures to produce the lighting designer's artistic vision. Such a system allows the lighting designer to quickly change looks and movements, and quickly iterate with different artistic ideas.

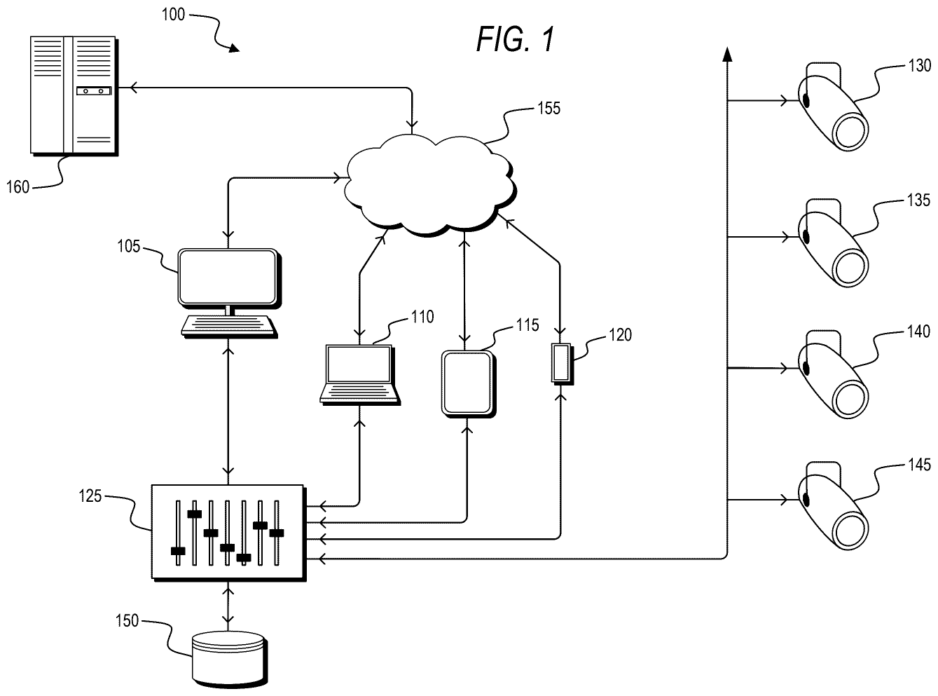

FIG. 1 illustrates a lighting system 100 for identifying and controlling one or more light fixtures using a natural language user input. The system 100 includes a plurality of user input devices 105-120, a control board or control panel 125, a first light fixture 130, a second light fixture 135, a third light fixture 140, a fourth light fixture 145, a database 150, a network 155, and a server-side computer or server 160. The plurality of user input devices 105-120 include, for example, a personal or desktop computer 105, a laptop computer 110, a tablet computer 115, and a mobile phone (e.g., a smart phone) 120.

Each of the devices 105-120 is configured to communicatively connect to the server 160 through the network 155 and provide information to, or receive information from, the server 160 related to the control or operation of the system 100. In some implementations, the server 160 is a representation of a server that is configured to host a cloud service, such as AWS or Azure. Each of the devices 105-120 is also configured to communicatively connect to the control board 125 to provide information to, or receive information from, the control board 125. The connections between the user input devices 105-120 and the control board 125 or the network 155 are, for example, wired connections, wireless connections, or a combination of wireless and wired connections. Similarly, the connections between the server 160 and the network 155, or between the control board 125 and the light fixtures 130-145 are wired connections, wireless connections, or a combination of wireless and wired connections.

The network 155 is, for example, a wide area network (“WAN”) (e.g., a TCP/IP based network), a local area network (“LAN”), a neighborhood area network (“NAN”), a home area network (“HAN”), or a personal area network (“PAN”) employing any of a variety of communication protocols, such as Wi-Fi, Bluetooth, ZigBee, etc. In some implementations, the network 155 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, a 5G New Radio, a Digital Enhanced Cordless Telecommunications (“DECT”) network, a Digital AMPS (“IS-136/TDMA”) network, or an Integrated Digital Enhanced Network (“iDEN”) network, etc.

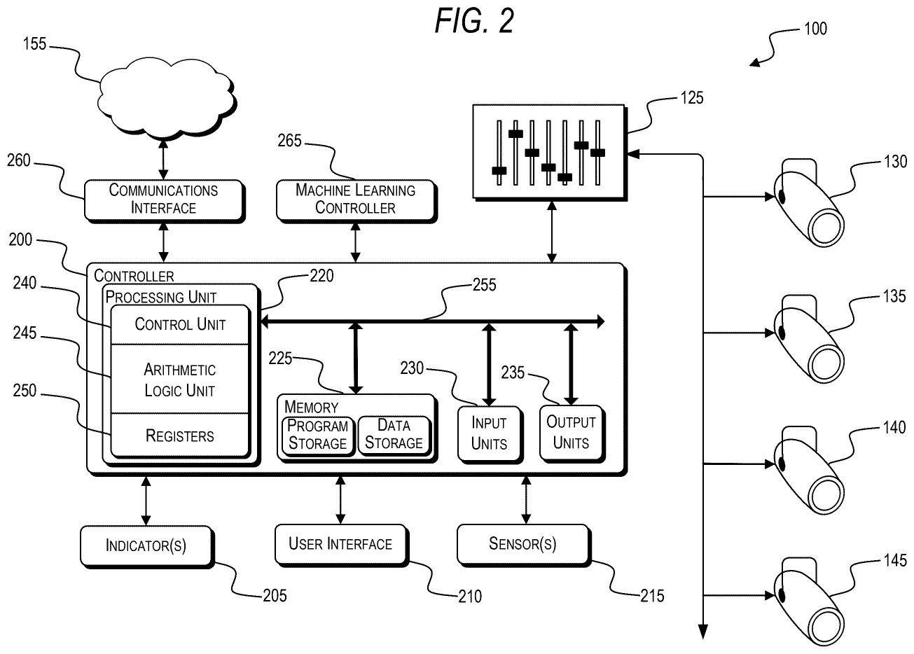

FIG. 2 illustrates a lighting fixture controller or controller 200 for the system 100. The controller 200 is electrically and/or communicatively connected to a variety of modules or components of the system 100. For example, the illustrated controller 200 is connected to one or more indicators 205 (e.g., LEDs, a liquid crystal display [“LCD”], etc.), a user input or user interface 210 (e.g., a user interface of the user input device 105-120 of FIG. 1), and one or more sensors 215 (e.g., a current sensor, a microphone, an optical sensor, etc.). The controller 200 is also connected to the control board 125, a communications interface 260, and a machine learning controller 265. The communications interface 260 is connected to the network 155 to enable the controller 200 to communicate with the server 160. The machine learning controller 265 is configured to train and/or execute one or more machine learning models associated with the control of the system 100. Although the machine learning controller 265 is illustrated as being directly connected to the controller 200, the machine learning controller 265 could also be integrated within the controller 200 or be located in another part of the system 100 (e.g., on the server 160). The controller 200 includes combinations of hardware and software that are operable to, among other things, control the operation of the system 100, control the operation of the light fixtures 130-145, communicate over the network 155, communicate with the control board 125, receive input from a user via the user interface 210, provide information to a user via the indicators 205, etc.

In the embodiment illustrated in FIG. 2, the controller 200 may be associated with one of the user input devices 105-120. As a result, the controller 200 is illustrated in FIG. 2 as being connected to the control board 125 which is, in turn, connected to the first light fixture 130, the second light fixture 135, the third light fixture 140, and the fourth light fixture 145. In other embodiments, the controller 200 is included within the control board 125, and, for example, the controller 200 can provide control signals directly to the first light fixture 130, the second light fixture 135, the third light fixture 140, and the fourth light fixture 145. In other embodiments, the controller 200 is associated with the server 160 and communicates through the network 155 to provide control signals to the control board 125 and the first light fixture 130, the second light fixture 135, the third light fixture 140, and the fourth light fixture 145.

The controller 200 includes a plurality of electrical and electronic components that provide power, operational control, and protection to the components and modules within the controller 200 and/or the system 100. For example, the controller 200 includes, among other things, a processing unit 220 (e.g., a microprocessor, a microcontroller, an electronic processor, an electronic controller, or another suitable programmable device), a memory 225, input units 230, and output units 235. The processing unit 220 includes, among other things, a control unit 240, an arithmetic logic unit (“ALU”) 245, and a plurality of registers 250 (shown as a group of registers in FIG. 2), and is implemented using a known computer architecture (e.g., a modified Harvard architecture, a von Neumann architecture, etc.). The processing unit 220, the memory 225, the input units 230, and the output units 235, as well as the various modules or circuits connected to the controller 200 are connected by one or more control and/or data buses (e.g., common bus 255). The control and/or data buses are shown in FIG. 2 for illustrative purposes. The use of one or more control and/or data buses for the interconnection between and communication among the various modules, circuits, and components would be known to a person skilled in the art in view of the embodiments described herein. In some implementations, the server 160 includes the same or similar hardware to that of the controller 200.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 220 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the system 100 and controller 200 can be stored in the memory 225 of the controller 200. The software includes, for example, firmware, one or more applications, program data, filters, rules, one or more program modules, lighting parameters, lighting instructions, and other executable instructions. The controller 200 is configured to retrieve from the memory 225 and execute, among other things, instructions and queries related to the control processes and methods described herein. In other embodiments, the controller 200 includes additional, fewer, or different components.

The user interface 210 is included to provide user control of the system 100 and/or light fixtures 130-145. The user interface 210 is operably coupled to the controller 200 to control, for example, drive signals provided to the light fixtures 130-145. The user interface 210 can include any combination of digital and analog input devices required to achieve a desired level of control for the system 100. For example, the user interface 210 can include a computer having a display and input devices, a touch-screen display, a keyboard, a plurality of knobs, dials, switches, buttons, faders, or the like. In the embodiment illustrated in FIG. 2, the user interface 210 is separate from the control board 125 (e.g., associated with one of the user input devices 105-120). In other embodiments, the user interface 210 is included in the control board 125.

The sensors 215 are connected to the controller 200 and are operable to detect events or conditions that occur within the system 100 or in a physical environment associated with the system 100. The sensors 215 may include one or more sensors including a current sensor, a microphone, an optical sensor, a camera (e.g., still camera or video), a rhythm sensor, a pitch sensor, a motion sensor, or the like. The sensors 215 may be physically integrated with the controller 200, the control board 125, and/or one or more of the light fixtures 130-145, or the sensors 215 may be separate or remotely located. For example, the sensors 215 may be positioned in a theater, on a stage, or in another interior or exterior space. Outputs from the sensors 215 may be utilized for controlling the system 100 and/or the light fixtures 130-145, for example, as prompts for driving light fixture operations, for determining precise locations of elements (e.g., light fixtures 130-145, fog machines, etc.) within the system 100.

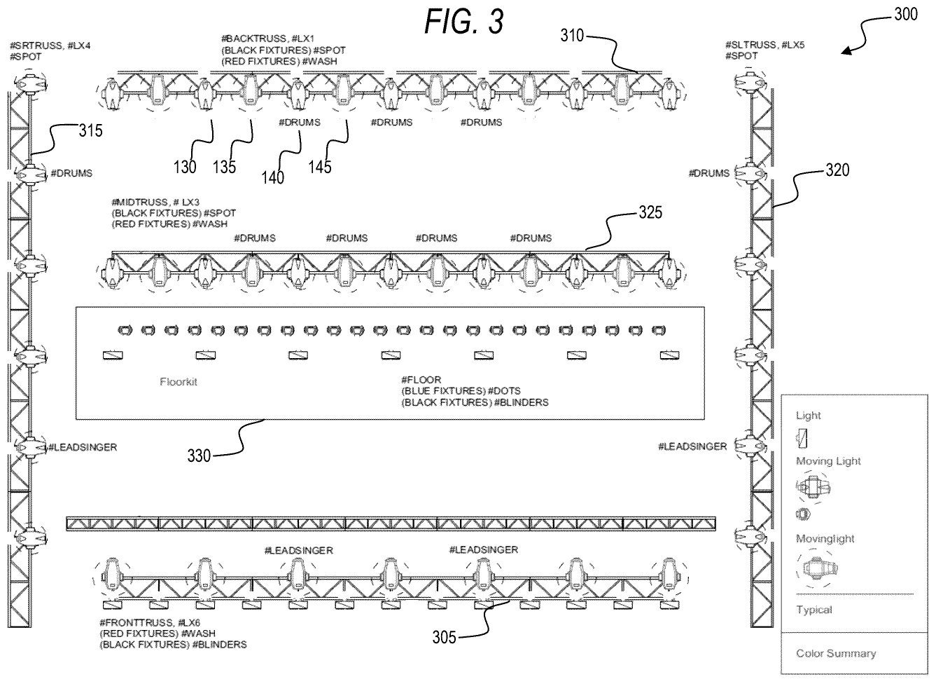

FIG. 3 illustrates an example map of light fixtures for a particular venue. In this example, a map 300 represents light fixtures that are attached to trusses of a lighting rig system, which may be assembled, for example, on a stage, in a theatre, or at an outdoor concert. The map 300 includes five trusses for securing the light fixtures including a front truss 305, a back truss 310, a stage right truss 315, a stage left truss 320, and a middle truss 325. The map 300 also includes a floor kit 330. Numerous light fixtures are attached to the trusses including the light fixtures 130-145 that are attached to the back truss 310. In general, the light fixtures are mapped to various locations on the stage for providing various types of lighting effects and functions. For example, wash lights provide a broad or unfocused beam of light and are positioned in the trusses to light a large area of the stage. Spotlights are positioned in the trusses to illuminate a narrow or hard edged area such as an ellipse on the stage. The spotlights may be directed to a specific location, for example, where a lead singer stands or where a drum kit is positioned. Dot lights are positioned in the floor kit 330 and may emit a narrow beam of light to highlight a particular object, such as a musical instrument. Blinder light fixtures are positioned in the floor kit 330 and may be utilized to illuminate an area of an audience. As shown in FIG. 3, the light fixtures 130-145 are attached to the back truss 310. Although FIG. 3 represents light fixtures attached to trusses on a stage or located on the floor of the stage, the disclosure is not limited in this regard, and the lights or light fixtures may be positioned in any type of indoor, outdoor, stationary, or mobile environment. Also, the light fixtures may be mechanically supported or may be positioned in the environment in any suitable manner.

To implement natural language inputs for controlling a lighting system, a detailed set of information about a particular venue is needed. For example, for each fixture illustrated in FIG. 3, the controller 200 should store or have access to information such as a unique identifier for each light fixture (e.g., an Eos channel number), the three-dimensional position of the light fixture within the venue (e.g., with respect to an origin point), three-dimensional positions of actor marks, three-dimensional positions of scenic elements, three-dimensional bounding volumes of scenic elements, surface material color and reflectance, a three-dimensional orientation of the light fixture (e.g., yaw, pitch, and roll), all controllable parameters of the light fixture (e.g., color mixing system, pan, tilt, iris, edge, zoom, strobe, shutter, gobo wheel, etc.), the static images that the fixture can project, all parameter constraints (e.g., achievable color gamut, min/max of each controllable parameter [e.g., degrees of pan], etc.), and any tags associated with the light fixture. In some implementations, other devices within the venue, such as fog machines, can similarly be cataloged with respect to their location and capabilities.

Regarding the tags for a light fixture, the map 300 also illustrates tags associated with the light fixtures. Tags may be used to characterize one or more light fixtures as a group based on, for example, a lighting function, a light fixture location, a lighting effect, an electrical source, or any another property that a user may associate with one or more lights. Table 1 (below) includes examples of tags shown in FIG. 3 along with corresponding descriptions or characteristics that the tags represent. This listing of tags is not intended to be exhaustive. Rather, these tags merely provide examples of some of the ways that light fixtures can be identified. A single tag may be associated with one or more of the light fixtures, and a single light fixture may be assigned to (e.g., associated with) one or more tags. For example, a spot light may be assigned to a tag identified in the map 300 as #SPOT. In another example, the light fixture 130 may be assigned to tags #BACKTRUSS, #LX1, and/or #SPOT. The light fixture 135 may be assigned to tags #BACKTRUSS, #LX1, and/or #WASH. The light fixture 140 may be assigned to tags #BACKTRUSS, #LX1, #SPOT, and/or #DRUMS. The light fixture 145 may be assigned to the tags #BACKTRUSS, #LX1, and/or #WASH.

TABLE 1
Tags and Associated Characteristics and Descriptions

| Tags | Tagged Light Fixtures and Characteristics |
|---|---|
| #FRONTTRUSS | Light fixtures located on a front truss |
| #SRTRUSS | Light fixtures located on a stage right truss |
| #BACKTRUSS | Light fixtures located on a back truss |
| #SLTRUSS | Light fixtures located on a stage left truss |
| #MIDTRUSS | Light fixtures located on a middle truss |
| #FLOOR | Light fixtures located on a floor |
| #LX1 | Light fixtures of electrical group 1 |
| #LX3 | Light fixtures of electrical group 3 |
| #LX4 | Light fixtures of electrical group 4 |
| #LX5 | Light fixtures of electrical group 5 |
| #LX6 | Light fixtures of electrical group 6 |
| #SPOT | Spot lights |
| #WASH | Wash lights |
| #DRUMS | Light fixtures directed at a drummer or a drum kit |
| #DOTS | Lights directed for highlighting objects |
| #BLINDERS | Lights directed at the audience |
| #LEADSINGER | Lights directed at a lead singer |
| #GOBO-LEAF | Gobos that have a leaf pattern |
| #INTERMISSION | State of all lighting elements during intermission |
| #AUTUMN-LEAVES | State with changing parameters |

As previously described, a number of lighting parameters of the light fixtures within the venue must also be known. The lighting parameters may indicate functions or qualities that a light fixture or a light is operable to perform or achieve. For example, the lighting parameters may indicate an on or off switch, a light color or palette, a light intensity, a movement or spatial orientation of a light fixture, a focus level, a gobo selection, and the like. In some implementations, the lighting parameters stored in the memory 225 or database 150 may include a variety of lighting pre-set instructions that can be used for controlling the light fixtures. For example, a lighting parameter reciting “blue at 100% intensity” may indicate that blue channels of a light fixture should be illuminated at their fullest intensity. In another example, a lighting parameter reciting “dim, 10 seconds” may indicate that the intensity of a lamp output should be lowered from a current intensity level to zero intensity over 10 seconds. In another example, a lighting parameter may define a palette, a gobo selection, and/or an action, such as spinning a gobo or LEDs of a light fixture. For example, when a number of gobos are selected and associated with a lighting parameter reciting “green, spin, 5 RPM” the parameter may be applied to the selected gobos by illuminating the gobos with a green palette and spinning the gobo wheels at 5 RPM.

All of these parameters associated with the venue and the light fixtures within the venue can be measured or determined and then cataloged. In some implementations, parameters like the capabilities of the light fixtures can be quickly gathered from manufacturer provided data or manuals that describe the operation of the light fixtures. With respect to the size or dimensions of the venue, they can be obtained manually or automatically with any available form of scanning equipment for mapping the venue and determining the spatial relationships among all of the elements within the venue. All of these parameters associated with the particular venue can then be stored, for example, in the memory 225 and/or database 150 as a complete representation of a particular venue's setup and functional capabilities. In some implementations, venue information can be stored separately from the light fixture information.

In some implementations, the information about the venue and light fixtures is stored in a common database software, such as MySQL, PostgreSQL, MongoDB, etc. The stored information can then be exposed or provided to machine learning models via an application programming interface (“API”) using a common framework such as Python with Flask/FastAPI, Node.js., etc. As a result, a natural language model (e.g., OpenAI's GPT-4) is able to query the database information via the API endpoints. This framework code can run on the server 160 or servers of a cloud service, such as AWS or Azure.

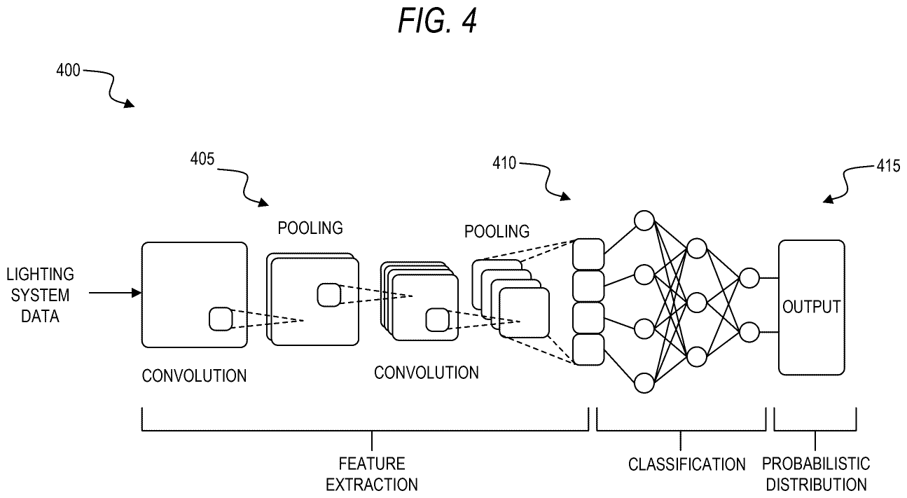

FIG. 4 illustrates a system 400 for training a machine learning model to understand the language of artistic design. For example, providing a control to a light fixture that says “blue at 80%” is not an interpretation of an artistic vision. Rather, it is a direct command telling a particular light fixture what color and at what intensity it should be driven. Instead, the system 400 can be used to train a machine learning model that can be used to take a particular artistic expression and ultimately convert that expression into a series of controls that can be used to produce the artistic expression with a set of light fixtures. The machine learning model illustrated in FIG. 4 is a convolutional neural network (“CNN”). However, other types of neural networks can also be used, such as a recurrent neural network (“RNN”), a long short-term memory (“LSTM”) neural network, among others. The model is provided with a large set of media (e.g., images, videos, etc.) related to lighting system data. For example, images of a venue with a plurality of lighting fixtures, different lighting fixture placements, different lighting effects, etc., being illustrated. The media will be tagged with artistic attributes that describe the scene in the image or video. For example, an image of a venue with a plurality of light fixtures being controlled can be tagged with a mood, color, harmony, texture, and spatial distribution or location (e.g., of the light fixtures). As the model is being trained, these tags corresponding to particular examples of lighting design will allow the model to associate those tags with particular controls of lighting fixtures. Although the model is being trained specifically for controlling a lighting system, more general artistic or emotional language for describing particular lighting designs can also be used. When training is complete, the trained model can be used to interpret an artistic vision from a natural language user input.

As described above, the system 400 is used to train a CNN. A CNN is a deep learning neural network architecture that is particularly well-suited to image classification and object recognition. The CNN will receive media (e.g., images or video) and transform the media into a feature map. The feature map can then be processed to produce a predicted output. First, the CNN receives input media. The received input media is specific to lighting system data. The system 400 includes a plurality of convolutional and pooling layers 405. The convolutional layers apply a set of filters to the input media, and each filter is configured to produce a feature map that highlights a specific aspect of the media. For example, the feature may be a location of a light fixture, an intensity of the light fixture, a color output of the light fixture, artistic components of lighting, etc. The artistic components of lighting include visibility, form, composition, mood, and information. Visibility relates to whether there is sufficient light to clearly see what is happening and to guide an audiences' attention to the parts of a stage or scene where important actions are taking place. Form relates to the use of shadows to create three-dimensional objects in the scene. Composition relates to how light fixtures are placed (e.g., symmetrically) and how colors are used to light the scene without sacrificing visibility or form. Mood relates to using color and color intensity to control the feel of the scene (e.g., warmer color tones suggest happiness and cooler color tones suggest sadness). Information relates to the expression to an audience of a location (e.g., interior space, exterior space), time of day, season, etc. The pooling layers then downsample the feature map to reduce its size while retaining the most important information from the feature map. As the feature map produced by a convolutional layer is passed through additional convolutional and pooling layers, each layer learns increasingly complex feature of the input media.

Although FIG. 4 illustrates only two convolutional layers and two pooling layers, the system 400 can include more than two of each such layers. The number of convolutional and pooling layers can be tailored to the system's complexity. The more complex the system that is being learned, the more layers that can be added. Additionally, the number of filters in each convolutional layer can be tailored to a particular system in order to optimize performance. For example, filters can be included in each convolutional layer that are intended to look for particular aspects of a lighting system that may be present in the media. As an illustrative example, filters in a first convolutional layer can be used to identify key elements within the media, such as human beings, furniture, building façade, vehicles, common props, etc. Once the prominent elements within a scene have been identified, filters can be used to determine how each of the elements is lit. For example, is an element well lit (e.g., to draw the audiences' focus) or poorly lit or dark (e.g., to not draw the audiences' focus). Filters can also be used to determine whether each element has a shadow. If a shadow is present, the CNN can determine how long the shadows are (e.g., in order to assess depth of the scene) and the angle of the shadow (e.g., in order to determine which light fixtures can be used to create the shadows at the correct angle). Further convolutional layers can use filters to identify specific lighting parameters, such as color, color temperature, sharpness or edges (e.g., which map to fixture parameters including zoom and edge), shapes of light beams on the floor (e.g., elliptical, shuttered to form other geometric shapes, etc.), and texture (e.g., is the light clean and punchy or more like sunlight through thick tree leaves). This information can be identified within the media for each of the identified key elements, which collectively describe what the audience would be looking at and can provide a sense of how a particular scene would make the audience feel. Following the final pooling layer, a fully-connected layer 410 is created that connects all of the neurons in the previous layer to all of the neurons in the next layer. The fully-connected layer 410 is responsible for combining the features learned by the convolutional and pooling layers to make a prediction that is then provided as an output 415 of the system 400.

In the context of understanding artistic expression as it pertains to the control of a lighting system, the system 400 can, from a given piece of input media, predict an artistic attribute of the media, such as mood, color, harmony, texture, etc., without relying upon the tagged information provided with the training media. The more media that is provided to the system 400, the more refined the model will become when evaluating new media. In some implementations, the CNN can leverage existing pre-trained models (e.g., related to things other than controlling a lighting system) to reduce the computational resources required to train the model.

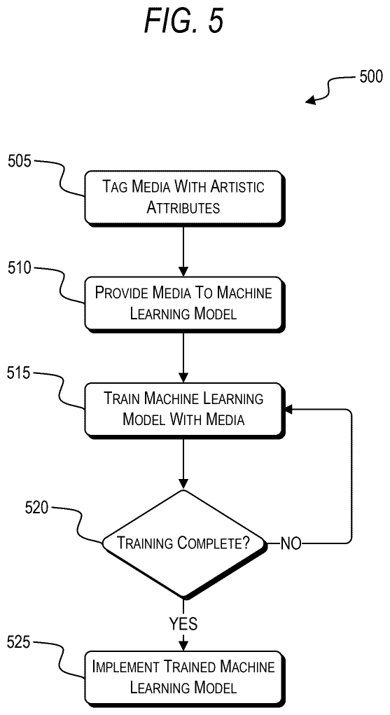

FIG. 5 is a process 500 corresponding to the training of the system 400 in FIG. 4. The process 500 begins with a set of media that will used to train an artistic vision trained model being tagged with a plurality of artistic attributes (STEP 505). For example, an image of a venue with a plurality of light fixtures being controlled can be tagged with a mood, color, harmony, texture, and spatial distribution or location (e.g., of the light fixtures). In other implementations, additional or different tags can be used to tag the media. The tagged media is then provided to a machine learning model (STEP 510). In some implementations, the machine learning model is a convolutional neural network (“CNN”). The machine learning model will then be trained using the media (STEP 515). As described above with respect to FIG. 4, the training process can include a plurality of convolutional and pooling layers that are used to extract features from the media. Ultimately, a fully-connected layer is produced that will then be used to generate a predicted output of the machine learning model. At STEP 520, the process 500 considers whether training is complete. In some implementations, training can be determined (e.g., by the controller 200) when all media has been provided to and analyzed by the system 400. In other implementations, training can be determined to be complete when a particular level of predictive accuracy of the machine learning model is achieved. For example, the machine learning model is capable of accurately predicting a mood from an input image with greater than 99% accuracy. If, at STEP 520, training of the machine learning model is not complete, the process 500 returns to STEP 515 to continue to train the machine learning model. If, at STEP 520, training of the artistic vision trained model is complete, the process 500 proceeds to STEP 525 where the artistic vision trained model can be implemented. In some implementations, the artistic vision trained model can be used in conjunction with and/or to train another machine learning model (e.g., a lighting control trained model).

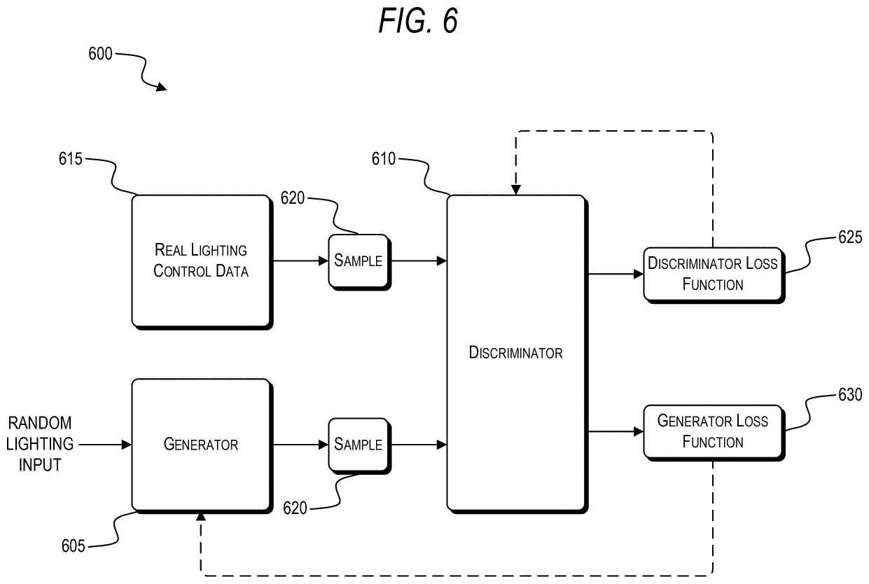

After the artistic vision trained model has been trained, another trained model will need to be generated in order to understand how to adjust fixture attributes to a achieve a desired lighting design. FIG. 6 illustrates a system 600 for training a lighting control trained model. The system 600 is illustrated as a generative adversarial network (“GAN”), although other networks could also be used. The GAN includes a generator 605 and a discriminator 610. The generator 605 is trained to generate plausible data. The discriminator 610 is trained to distinguish between real data that is provided to the discriminator 610 and fake data that is generated by the generator 605. In some implementations, both the generator 605 and the discriminator 610 are neural networks. The discriminator 610 is, for example, a classifier that is used to distinguish between real and fake data. For example, the discriminator 610 is configured to receive real lighting control data 615. The real lighting control data can, for example, be a prompt for a specific lighting design that uses artistic language to identify a desired control of a lighting system. In some implementations, the real lighting control data corresponds to specific lighting controls for a light fixture (e.g., setting a color, an intensity, an angle, etc.) that can be produced by the lighting fixtures in a real-world lighting system. In some implementations, the real lighting data is the data used to train the artistic vision trained model. The fake data is provided to the discriminator 610 by the generator 605. The sample boxes 620 are merely illustrated to represent the data sources feeding data into the discriminator 610. When training the discriminator 610, the generator 605 is not being trained (e.g., any current weights and biases remain constant while generating fake example lighting controls).

The discriminator 610 is connected to two loss functions. The first loss function is a discriminator loss function 625, and the second loss function is a generator loss function 630. As the discriminator 610 is being trained, the discriminator ignores the generator loss function 630, which will instead be used during generator training. During discriminator training, the discriminator classifies both real and fake data. The discriminator loss function 625 penalizes the discriminator 610 for misclassifying a real instance of data as fake or a fake instance of data as real. The discriminator 610 can update its weights through backpropagation from the discriminator loss function 625.

The generator 605 is configured to create fake data by incorporating feedback from the discriminator 610. The generator 605 receives a random lighting control input, and transforms the random lighting control input into a fake output. The fake output is classified by the discriminator 610, and backpropagation is used to update weights and biases of the generator 605 to improve the ability of the generator 605 to generate fake data. The generator loss function 630 penalizes the generator for producing a sample that the discriminator 610 classifies as fake.

The generation of the fake output by the generator 605 can correspond to the control of, for example, a virtual light fixture or virtual lighting system including a plurality of virtual lighting fixtures (e.g., an image of the light fixture or light fixtures). The discriminator 610 is configured to evaluate the control of the virtual light fixture(s) to determine whether the control of the virtual light fixture(s) corresponds to a real control for the light fixture (e.g., a real image of a light fixture) or a generated virtual fixture (i.e., from the generator 605). In some implementations, the discriminator 610 can incorporate the artistic vision trained model in order to evaluate the artistic vision of both real and fake virtual fixtures. For example, the artistic vision trained model could be used to evaluate a generated control for a virtual fixture and compute a score for how well the generated control for a virtual fixture matches a real world control for a real world fixture (e.g., mood, color, harmony, texture, etc.). As an illustrative example, the discriminator 610 can cycle through each gobo image, project the gobo image into the virtual scene, determine what type of mood each gobo image evokes, and score how well each gobo image evokes that mood. Completing such an action for each fixture will allow a user to call for a specific mood and the model to select the gobo image that produced the highest score for the specific mood within given mechanical constraints, such as attack angle, pan/tilt, distance and lumen output, etc. Accordingly, the model will be able to help a lighting designer choose the correct fixture for a scene without the lighting designer having to know specific details of particular fixtures. If the computed score is below a threshold value, the discriminator can identify the control of the virtual fixture as fake and the generator 605 will eventually by updated by backpropagation. Over a large number of learning cycles, the generator 605 will eventually be able to generate controls for a virtual fixture that cannot be accurately identified by the discriminator. When fully-trained, the discriminator will have an accuracy of 50% because the discriminator 610 is not able to distinguish between the real lighting controls and the generated lighting controls.

The end result of the system 600 is a lighting control trained model that is capable of receiving an input, understanding the artistic nature of an input (e.g., including multiple different forms of artistic expression, such as mood, color, etc.), and generate lighting controls that will control one or more light fixtures to generate the desired controls. In some implementations, the lighting control trained model is itself able to interpret artistic expression based on the use of the artistic vision trained model during the training of the lighting control trained model. In some implementations, the lighting control trained model and the artistic vision trained model can be used together to both interpret, for example, a natural language user input of a desired lighting control and generate the corresponding lighting controls necessary to implement the desired lighting control in a real-world venue. The lighting control trained model, or the lighting control trained model and the artistic vision trained model, can represent a global understanding of the relationships between light fixture attributes and light. Using this global understanding, and once provided with complete representation of a particular venue's setup and functional capabilities, the lighting control trained model will be able to generate the correct controls for the existing light fixtures in the venue to achieve the desired lighting control. In some implementations, the lighting control trained model can be specifically trained for a particular venue (e.g., for a venue that is frequently used).

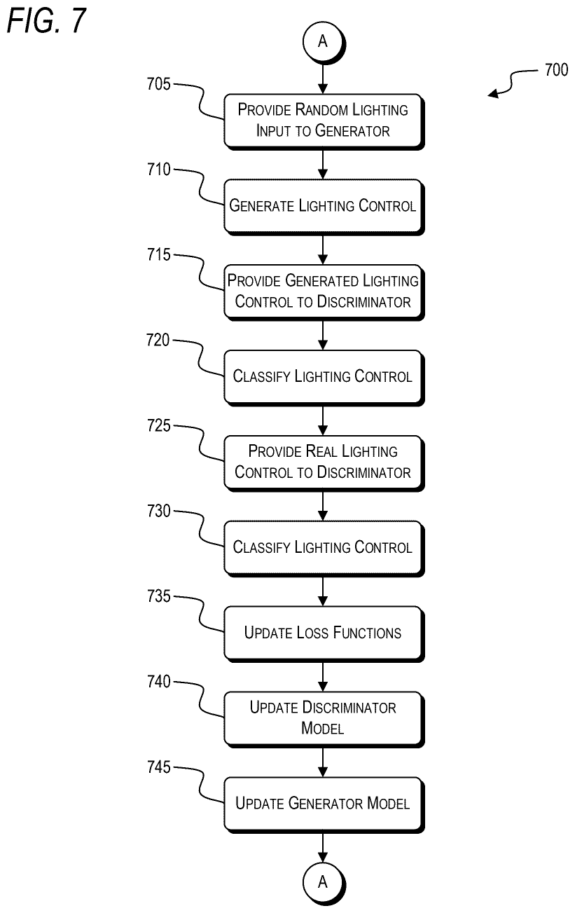

FIG. 7 is a process 700 corresponding to the training of the system 600 in FIG. 6. The process 700 begins with providing a random lighting input to the generator 605 (STEP 705). Based on the random lighting input, the generator 605 will generate a fake lighting control (STEP 710). As described above with respect to FIG. 6, the fake lighting control can be in the form of a control of a virtual light fixture or an image of a virtual light fixture. The generated lighting control is provided to the discriminator 610. The discriminator 610 will evaluate the generated lighting control to determine whether the generated lighting control is real or fake. At STEP 710, the discriminator 610 classifies the generated lighting control as fake or real. At STEP 725, a real lighting control is provided to the discriminator 610, and the discriminator 610 again classifies the generated lighting control as fake or real (STEP 730). At STEP 735, both the discriminator loss function 625 and the generator loss function 630 are updated. In some implementations, the discriminator loss function and generator loss function can be updated after each classification. After the loss functions have been updated, backpropagation can be used to update the discriminator model (STEP 740) and the generator model (STEP 745). The process 700 will continually repeat until training of the lighting control trained model is completed, and the generator 605 is capable of generating lighting controls that the discriminator 610 cannot distinguish as fake.

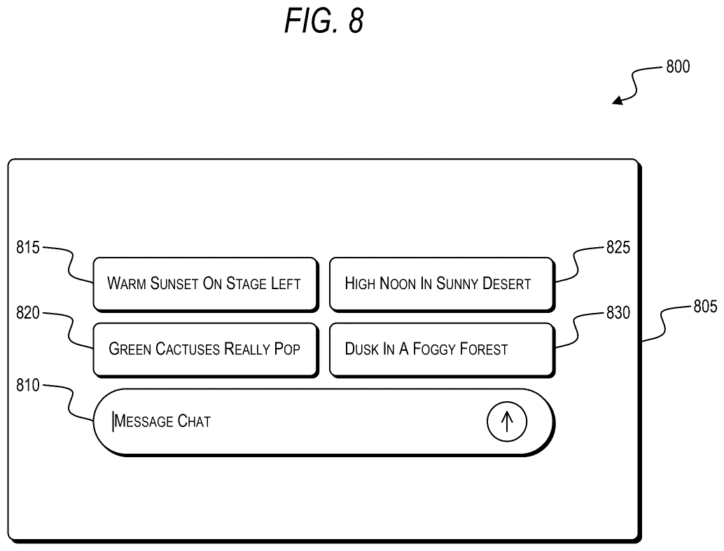

FIG. 8 illustrates an interface 800 for providing natural language user inputs for controlling a lighting system. The interface 800 can, for example, be within the user interface 210 of one of the devices 105, 110, 115, 120. The interface 800 includes a window 805 that includes a prompt 810 for inputting a natural language input. For illustrative purposes, the prompt is illustrated as an input for typing a natural language command. However, the natural language input can similarly be provided via voice-to-text conversion that is commonly available. As a result, a user's input is verbal (written or spoken) to provide the natural language input to control the lighting system. As illustrated in FIG. 8, the window also includes selectable natural language commands 815, 820, 825, 830 for the lighting system. The selectable natural language commands 815, 820, 825, 830 can correspond to recent inputs that have been received by the interface 800, common inputs that have been received by the interface 800, user preference inputs that a particular user prefers, preset inputs, etc. The selectable natural language commands 815, 820, 825, 830 have the same effect as a user speaking or typing a natural language command into the prompt 810.

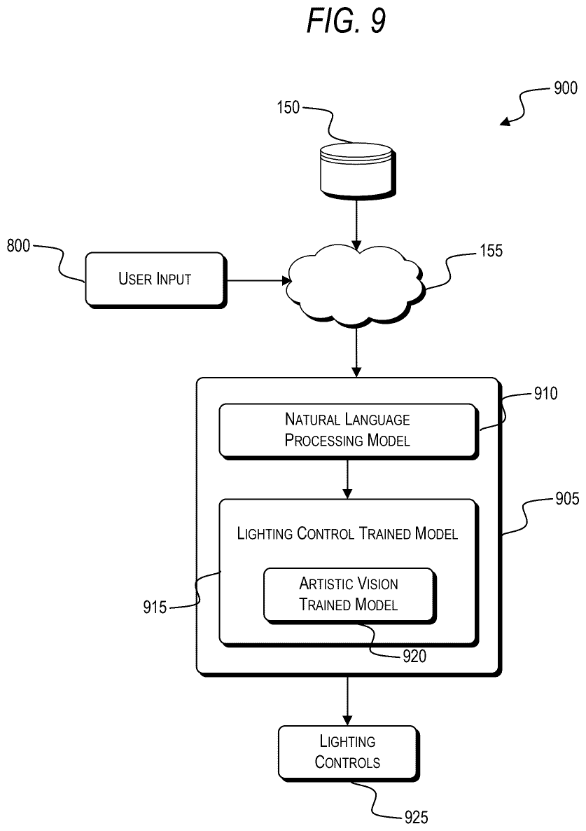

Once a user has provided a natural language user input to the interface 800, the system will take that natural language user input and output lighting controls that correspond to the natural language user input. For example, FIG. 9 illustrates an exemplary system 900 for providing natural language user inputs for controlling a lighting system. The system 900 includes the database 150, the network 155, the user input from the interface 800, and a machine learning controller 905. In some implementations, the machine learning controller 905 includes the same or similar hardware to the controller 200. As previously described, the database 150 stores information related to a particular venue (e.g., dimensions, layout, etc.) and information about all of the light fixtures (and other equipment) associated with than venue that can be controlled. The controller 200 connects to the server 160 or a cloud service (e.g., AWS, Azure, etc.) hosted on the server 160 and exposes or provides the information related to the venue and light fixtures to the machine learning controller 905. The user interface 800 is used to provide a natural language user input to the machine learning controller 905.

The machine learning controller 905 interprets the natural language user input using a natural language processing model 910. Natural language processing, as performed by the natural language processing model 910, is well-known. An example of a suitable natural language processing model that could be used by the system 900 would be, for example, the OpenAI's GPT4, although other natural language processing models could also be used. Because natural language processing is well-known, only a higher level description of the natural language processing model 910 is provided. After the machine learning controller 905 and the natural language processing model 910 receive the natural language user input, the natural language processing model 910 will evaluate the natural language user input and find relationships between the constituent parts of the input (e.g., letters, words, phrases, etc.). In some implementations, preprocessing of the natural language user input is performed. Preprocessing can be performed to improve the model's performance and/or convert words and characters into a format that the model will be better able to understand. Some options available to the natural language processing model 910 for preprocessing include stemming and lemmatization, sentence segmentation, stop word removal, and tokenization. Each of these preprocessing techniques could be performed by a submodule within the natural language processing model 910. Stemming relates to converting words to their base forms using heuristic rules. Lemmatization is used to analyze a word's morphology to find a root using basic vocabulary (e.g., from a dictionary). Sentence segmentation is used to break the natural language user input down into meaningful sentence units. Stop word removal can be used to remove common words that are not particularly relevant to the user input, and tokenization is used to split text into words or word fragments.

Following preprocessing, the natural language processing model can use a variety of techniques to process the user input. For example, logistic regression, Naive Bayes, and decision trees can all be used by the natural language processing model 910 to process the user input. Logistic regression is a supervised classification algorithm that predicts a probability that an event will occur based on an input. Naive Bayes is a supervised classification algorithm that finds a conditional probability distribution using a Bayes formula and makes a prediction based on which joint distribution has the highest probability. Decision trees are supervised classification models that split a data set based of features that maximize information gain for each split. Other techniques that can be utilized by the natural language processing model 910 include Latent Dirichlet Allocation, hidden Markov models, convolutional neural networks (“CNN”), recurrent neural networks (“RNN”), autoencoders, and the like.

After the natural language user input has been processed and the machine learning controller 905 understands to user input, the trained models described above with respect to FIGS. 4-7 can be used to generate the lighting control commands needed to effectuate the native language user input. For example, after the generator 605 described above with respect to FIG. 6 has been fully or sufficiently trained, the generator 605 can be used to generate lighting controls based on natural language user inputs. The generator 605 is illustrated in FIG. 9 as a lighting control trained model 915. The lighting control trained model 915 is configured to receive the processed user input from the natural language processing model 910, as well as the information from the database 150 related to a particular venue (e.g., dimensions, layout, etc.) and information about all of the light fixtures (and other equipment) associated with than venue that can be controlled.

The lighting control trained model 915, similar to how the generator 605 functioned with respect to FIG. 6, takes the processed user input, the venue information, and the light fixture information and generates a corresponding set of lighting controls for controlling the light fixtures in the venue based on the natural language user input. In some implementations, the lighting controls will only correspond to those fixtures that need to be controlled to achieve the intended artistic vision from the natural language user input. In other implementations, the lighting controls can correspond to a comprehensive set of lighting controls for all of the light fixtures in the venue (e.g., even for those light fixtures that are not changing). In some implementations, the lighting control trained model 915 also receives the current state of the light fixtures in the venue from the database 150. As a result, the lighting control trained model 915 would understand what the current settings and state of the venue are, and then be used to determine how to modify those current settings to achieve the artistic vision from the natural language user input. In some implementations, the current settings are provided to the lighting control trained model 915 in a closed loop manner. In other implementations, the lighting control trained model 915 stores settings in memory and assumes, for example, that the lighting controls that were previously generated were actually applied. As a result, the lighting control trained model 915 would have knowledge of the current settings.

As previously described, the generator 605 was trained using the model that had already been trained to understand artistic expression, as described with respect to FIG. 4. As a result, the generator 605 has the capability understanding artistic expression based on its own training. However, the lighting control trained model 915 can also utilize the artistic expression trained model described with respect to FIG. 4. The artistic expression trained model is illustrated in FIG. 9 as an artistic expression trained model 920. In some implementation, the lighting control trained model 915 can use the artistic expression trained model to combine multiple artistic moods or artistic expressions into a new artistic expression that incorporates each of the multiple artistic moods. After the lighting control trained model generates the lighting controls for controlling the light fixtures in the venue, the machine learning controller 905 outputs lighting controls 925. The lighting controls can, as an example, specify a light fixture by a unique identifier (e.g., Eos Channel 10), a parameter name to be controlled (e.g., intensity), and a parameter value (e.g., 75). This is merely an illustrative example, and any number of different parameters can be controlled at the same time based on the desired control of the system. The lighting controls 925 can then be returned, for example, through the network 155 to the controller 200. In some implementations, the lighting control trained model 915 and/or the artistic expression trained model 920 can continue to be trained as the system 900 is being used.

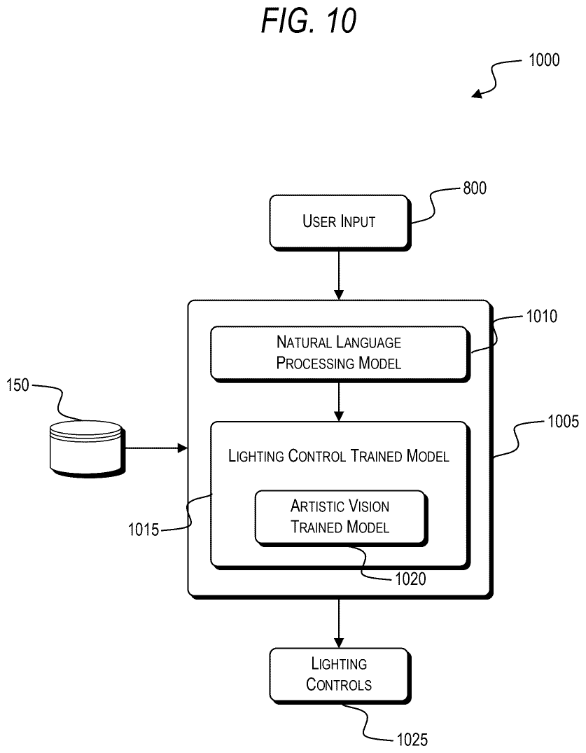

FIG. 10 illustrates another exemplary system 1000 for providing natural language user inputs for controlling a lighting system. The system 1000 includes the database 150, the user input from the interface 800, and a machine learning controller 1005. Similar to the system 900 described with respect to FIG. 9, the system 1000 also includes a natural language processing model 1010, a lighting control trained model 1015, and an artistic vision trained model 1020. From a functional standpoint, the system 1000 operates in substantially the same manner as the system 900 to output lighting controls 1025. However, the system 1000 does not rely upon the network 155. Rather, the system 1000 is configured to be executed locally, and is not dependent upon a server or cloud services. The trained models can be trained and stored locally such that they can be accessed without having to rely upon, for example, an Internet connection and third-party or external servers. For example, the machine learning controller can be implemented by the controller 200 of one of the devices 105-120.

After the lighting controls have been generated by the system 900, 1000, the controller 200 utilizes the lighting controls to generate drive signals for each of the affected light fixtures (i.e., light fixtures that need to be controlled to effect the natural language user input), and transmits the drive signal signals to the specified light fixtures. The specified light fixtures are then controlled through the control panel 125 based on the drive signals to perform or apply the generated lighting controls. As previously described, the lighting controls can control any aspect of the light fixture. For example, the generated lighting controls can include values for each of a color, a pan value, a tilt value, an iris value, an edge value, a zoom value, a strobe value, a shutter vale, a gobo value, etc., for the light fixture. As an illustrative example, the lighting controls can control a gobo to project an image (e.g., a leaf breakup, a star, a logo, etc.) onto a subject in the scene. The gobo is used to add additional texture to a scene, to mimic a certain location, such as an outdoor scene with sunlight filtering through tree leaves, or mimic an effect of, for example, a disco ball projecting many small points of light at a stage. Similarly, the lighting controls can be used to control gobo rotation at varying speeds. Slow, subtle speed can be used to convey serenity, and faster rotation can be used to convey chaos or high activity. The lighting controls can also be used to control beam angle. For example, a smaller beam angle can be used to produce a defined column of light, and many fixtures doing this at the same time can dominate a scene with sharp lines from floor to ceiling. Narrow beams can also be used to draw the audience into a very specific area of focus, such as an upper body of an actor during an important speech. The lighting controls can also be used to control edges or diffusion (e.g., sharp beam edges or soft blurry edges) and how the edges map to emotion (e.g., stark/austere versus warm/cozy). The lighting controls can also be used to control framing shutters to allow for the creation of beams of light pools with a specific geometry (e.g., rectangle, triangle, etc.). The lighting controls can also be used to control strobing to flash a light at varying speeds. Strobe effects can be used to create ominous lighting or to convey anxiety. These are just a few examples of how the lighting controls can be used to achieve an artistic vision for a scene and is not intended to be comprehensive.

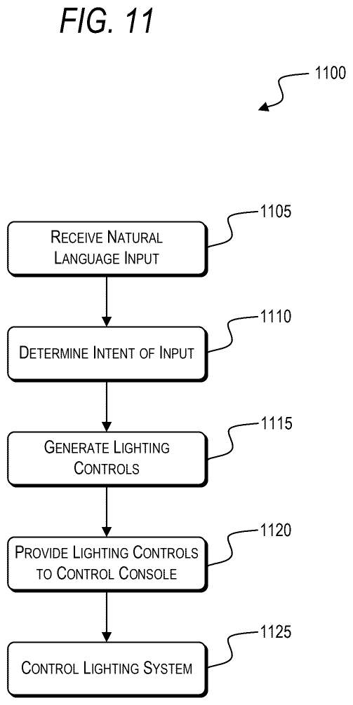

FIG. 11 is a process 1100 for controlling a lighting system based on a natural language user input. The process 1100 can be implemented in either the system 900 or the system 1000. The process 1100 begins with the system receiving a natural language user input (STEP 1105). As previously described, the natural language user input can be a verbal input (i.e., written or spoken), and can be received through a interface, such as interface 800. After the natural language user input has been received, the system is configured to interpret or determine the intent of the user input (STEP 1110). As described above with respect to FIG. 9, determining the intent (e.g., including the artistic intent of the user input) can be accomplished using a combination of trained models. For example, a natural language processing model, a lighting control trained model, and an artistic vision trained model can all be used in combination to determine the intent of the user input. After the intent of the user input has been determined, the system then generates or determines the lighting controls that are required to effectuate the intent of the user input (STEP 1115). The controls, for example, correspond to specific lighting control values for specific light fixtures (e.g., color, intensity, direction, angle, etc.). The lighting controls are then provided to a lighting control console (e.g., control panel 125) (STEP 1120), and the lighting system is correspondingly controlled (STEP 1125), as previously described.

Thus, embodiments described herein provide, among other things, systems, methods, and devices for controlling the outputs of one or more light fixtures based on a natural language user input. Various features and advantages are set forth in the following claims.

What is claimed is:

1. A lighting system comprising:
a lighting fixture;
a user input;
a machine learning controller configured to implement a natural language processing model and a lighting control trained model; and
a lighting fixture controller connected to the lighting fixture, the lighting fixture controller including an electronic processor and a memory coupled to the electronic processor, the memory storing instructions that when executed by the electronic processor configure the electronic processor to:
receive, through the user input, a natural language user input related to a desired lighting control for the lighting system,
provide the natural language user input to the machine learning controller to be processed by the natural language processing model and the lighting control trained model,
receive, from the machine learning controller, an output lighting control for controlling the lighting fixture,
generate a drive signal for the lighting fixture based on the output lighting control, and
transmit the drive signal to the lighting fixture to control an output of the lighting fixture to achieve the desired lighting control.

2. The lighting system of claim 1, wherein the lighting control trained model is a generative adversarial network (“GAN”).

3. The lighting system of claim 1, wherein the natural language user input is a verbal user input.

4. The lighting system of claim 3, wherein the user input includes a prompt for inputting the natural language user input.

5. The lighting system of claim 1, further comprising:
a server including the machine learning controller,
wherein the lighting fixture controller is configured to communicate with the server over a network to provide the natural language user input to the machine learning controller and to receive the output lighting control for controlling the lighting fixture.

6. The lighting system of claim 5, wherein the server is configured to host a cloud service.

7. The lighting system of claim 1, wherein the machine learning controller is further configured to implement an artistic expression trained model.

8. The lighting system of claim 7, wherein the artistic expression trained model is a convolutional neural network (“CNN”).

9. The lighting system of claim 1, wherein the lighting fixture controller is further configured to provide information about a venue and the lighting fixture to the machine learning controller.

10. The lighting system of claim 9, further comprising:
a plurality of lighting fixtures, the plurality of lighting fixtures connected to the lighting fixture controller,
wherein the lighting fixture controller is further configured to:
provide information about each of the plurality of lighting fixtures to the machine learning controller, and
receive, from the machine learning controller, a plurality of output lighting controls for controlling each of the plurality of lighting fixtures.

11. A method of controlling a lighting system including a lighting fixture, the method comprising:
receiving, through a user input, a natural language user input related to a desired lighting control for the lighting system;
providing, to a machine learning controller, the natural language user input for processing by a natural language processing model and a lighting control trained model;
receiving, from the machine learning controller, an output lighting control for controlling the lighting fixture;
generating, using a lighting fixture controller, a drive signal for the lighting fixture based on the output lighting control; and
transmit the drive signal to the lighting fixture to control an output of the lighting fixture to achieve the desired lighting control.

12. The method of claim 11, wherein the lighting control trained model is a generative adversarial network (“GAN”).

13. The method of claim 11, wherein the natural language user input is a verbal user input.

14. The method of claim 13, wherein the user input includes a prompt for inputting the natural language user input.

15. The method of claim 11, further comprising:
communicating, from the lighting fixture controller, with a server over a network for providing the natural language user input to the machine learning controller and for receiving the output lighting control for controlling the lighting fixture.

16. The method of claim 11, wherein the machine learning controller further includes an artistic expression trained model.

17. The method of claim 16, wherein the artistic expression trained model is a convolutional neural network (“CNN”).

18. The method of claim 11, further comprising:
providing, using the lighting fixture controller, information about a venue and the lighting fixture to the machine learning controller.

19. A lighting system comprising:
a plurality of lighting fixtures;
a user input;
a machine learning controller configured to implement a natural language processing model and a lighting control trained model; and
a lighting fixture controller connected to the plurality of lighting fixtures, the lighting fixture controller including an electronic processor and a memory coupled to the electronic processor, the memory storing instructions that when executed by the electronic processor configure the electronic processor to:
receive, through the user input, a natural language user input related to an artistic lighting expression for the lighting system,
provide the natural language user input to the machine learning controller to be processed by the natural language processing model and the lighting control trained model,
receive, from the machine learning controller, output lighting controls for controlling the plurality of lighting fixtures,
generate drive signals for the plurality of lighting fixtures based on the output lighting controls,
transmit the drive signals to the plurality of lighting fixtures, and
control outputs of the plurality of lighting fixtures using the drive signals to achieve the artistic lighting expression.

20. The lighting system of claim 19, wherein the natural language user input is a verbal user input.
